(19) United States
(12) Patent Application Publication
(10) Pub. No.: US 2006/0174331 A1
(43) Pub. Date: Aug. 3, 2006

(54) Method for signing a user onto a computer system

(75) Inventor: Harald Schuetz, Linz (AT)

Correspondence Address: WILLIAM COLLARD;COLLARD & ROE, P.C., 1077 NORTHERN BOULEVARD, ROSLYN, NY, 11576, US

(73) Assignee: Utimaco safeware AG, Oberursel (DE)

(21) Appl. No.: 11/345,560

(22) Filed: Feb. 1, 2006

(30) Foreign Application Priority Data
Feb. 2, 2005 (DE) 10 2005 004 902.8

(51) Int. Cl. H04L 9/32

(52) U.S. Cl. 726/5

(57) ABSTRACT

A method for signing a user on to a computer system, whereby the user identifies himself/herself on the computer system by means of a certificate, and is authenticated in the computer system by means of sign-on data. In order to avoid the need for an authentication server, which furthermore allows user roaming, the sign-on data are determined in the computer system from the certificate.

### BACKGROUND OF THE INVENTION

1. Field of the Invention

The invention relates to a method for signing a user on to a computer system, whereby the user identifies himself/herself on the computer system by means of a certificate, and is authenticated in the computer system by means of sign-on data.

2. The Prior Art

On generally known computer systems, for example with the Microsoft Windows NT operating system, it is only possible to work after signing on, since the file system sets or refuses access entitlements with reference to individual users. During sign-on, an authentication software, in the case of NT the system-inherent module GINA (Graphical Identification and Authentication) is started by the log-on process. This is responsible, along with the known welcome page and the “fast user switch-over,” for identifying and authenticating users of a computer, but can be replaced or re-written by third-party manufacturers, in order to change the sign-on procedure. Only after the user has successfully signed on—in other words after he/she has input the user name and the related password—is an “access token” created, a success message returned to the log-on process, and the interface configured for the user called up.

Generally known methods of the type stated initially, for signing on a user to an NT computer system, by means of a certificate, are based on Kerberos (www.fags.org/rfcs/rfc1510.html), a network protocol developed for authentication in open and non-secure computer networks (for example the Internet). When the user signs on using the known method, at least two computer systems are involved: the computer system on which the user is signing on, the Kerberos server and, if applicable, additional servers that the user wishes to utilize by way of the computer system. The Kerberos server first authenticates itself to the computer system and servers, and verifies their identity, and then both the computer system relative to the servers and the servers relative to the computer system, in order to prohibit man-in-the-middle attacks. The known methods based on Kerberos therefore support a “single sign on” (SSO) of the user: After one-time sign-on by the user, the Kerberos network service takes on the authentication of the latter for the use of additional network services.

Various methods, also generally known, that are based on Kerberos allow sign-on by a user by means of a smartcard. Sign-on by means of a smartcard replaces the simple, knowledge-based sign-on of a user by means of user name and password with a method that requires personal possession of the smartcard. In this connection, the certificate stored on the smartcard is released only after the related PIN has been input—for example by way of a keyboard field integrated into the reader device for the smartcard—so that the known methods guarantee increased security against misuse by means of an additional knowledge-based component.

### SUMMARY OF THE INVENTION

It is therefore an object of the invention to provide a method for signing on by means of a certificate, which does not require a separate server for authentication and that furthermore allows the roaming of users.

This object is accomplished according to the invention by providing a method in which the sign-on data are determined in the computer system from the certificate. The method according to the invention, like the known methods, can replace a knowledge-based log-on procedure based on inputting user name and password with a procedure that is based on possession (of the certificate), but in contrast to the known methods, it does not require a separate server for authentication.

In a preferred embodiment of the method according to the invention, user name and password are calculated from the certificate as sign-on data. The use of a calculated—in other words cryptic—user name instead of a “clear name” as personalized log-on information offers yet again clearly greater security against unauthorized sign-on on a computer system, as compared with the use of only a (cryptic) password as the proof of entitlement from the certificate.

Fundamentally, methods according to the invention that calculate only the password for use with a clear name, or also only the user name (for use in a system that does not allow inputting a password, for example), or any desired other secret from the certificate, are also possible as alternatives.

The certificate is preferably read from a smartcard by means of a reader device connected with the computer system. The use of smartcards and reader devices allows particularly cost-effective implementation of a method according to the invention, by means of the use of mass-produced articles. Fundamentally, the smartcard can be read from any desired medium that is accessible to the system at the time of the sign-on.

Such a method according to the invention is particularly secure if the user inputs an identification code (“personal identification number,” PIN) assigned to the certificate into the reader device and thereby releases the certificate. Thus, the method according to the invention is secured by means of an additional knowledge-based component.

### DETAILED DESCRIPTION OF THE PREFERRED EMBODIMENT

The invention will be explained in the following, using an exemplary embodiment. In order to set up a new user on an NT computer system (single workstation or network server), his/her last name is used as a user name. If another user with the same last name is already set up, the new user name is supplemented with a sequential number. The user name is stored in a certificate as a clear name (in the field “/CN,” “common name”), and the certificate is stored on a smartcard. The smartcard is given to the user, along with the PIN that is required to release the certificate.

Then, in the set-up module, a cryptic password is generated from the certificate, by means of a mathematical algorithm: In general, individual data are extracted from the certificate, and these are optionally hashed. By means of an ID word function, a (preliminary) ID word is calculated from the (hashed) data as well as additional parameters. The parameters used are divided into public and secret parameters. Examples of public parameters are start or initialization vectors. The secret parameters include any cryptographic keys that are used.

The ID word function must be selected in such a manner that it is practically impossible to calculate functional values of the ID word function without knowing the secret parameters that have been used. Examples of such ID word functions are symmetrical coding algorithms as well as algorithms for the creation of digital signatures or Message Authentication Codes (MACs). If necessary, the (preliminary) ID word is recoded or shortened to meet restrictions of the target system for passwords or credentials.

For example, a predefined start vector is first selected in order to calculate the password, and the user name is hashed. The resulting hash code is signed with the certificate and alphanumerically recoded and, if necessary, shortened, so that it meets the restrictions of the target system for passwords.

To sign on to the computer system (or to NT clients that are connected with the network server), the user places the smartcard into a locally connected reader device and inputs the PIN, which only he/she knows. The sign-on module, which is installed on the computer system in place of the original GINA module, reads the certificate and determines the user name and password of the user for signing on, according to the same algorithm, and signs the user on to the network.

The user's password is not known to the user himself/herself, nor to third parties, since it is never stored but always only calculated as needed and automatically processed further. Since the password also does not have to be memorized by a user, the complete spectrum is available, up to the maximally allowed length for this password, as is the complete character range, including characters that cannot be input via the keyboard or displayed on the screen. From an administrative point of view, the method according to the invention permits use of the strictest rules—including regularly changing the password by means of changing the algorithm that is used in the set-up and sign-in modules, for example by means of public parameters for this algorithm, without any restriction of the usability of the computer system.

The method according to the invention can be used in the same manner not only for signing on to NT computer systems, but rather is fundamentally suitable also for other operating systems or also for authentication for individual applications in computer systems. DES, 3DES, AES, RC4, RSA signatures or HMAC can be used for the ID word function, among others, and MD5, RIPEMD-160, and SHA-1 can be used as the hash function, among others.

The user's certificate can be stored, alternative to the use of a smartcard, on any desired portable data media, for example on a USB stick or on RAM cards or also on a PDA, and can be transmitted to the computer system by way of cables (for example USB, serial or parallel) or via another interface (for example infrared, Bluetooth, WLAN, GSM, or by SMS).

In this connection, the portable data medium may serve only as a memory for the certificate and the secret parameters of the ID word function, and transmit these to the computer system for further calculations. However, it is also possible that the portable data medium has not only a memory unit but also a computer unit, so that the ID word can be completely calculated on the card and is transmitted to the computer system only after the calculations have been concluded.

Furthermore, mixed forms of the approaches described are possible. Thus it is possible, for example, that the calculation of the ID word is taken over partly by the portable data medium and partly by the computer system, or that the certificate is stored on the computer system, and only parameters for the ID word function are stored on the portable data medium.

Accordingly, while only a few embodiments of the present invention have been shown and described, it is obvious that many changes and modifications may be made thereunto without departing from the spirit and scope of the invention.

What is claimed is:

1. A method for signing a user on to a computer system, comprising:
identifying the user on the computer system by means of a certificate; and
authenticating the user in the computer system by means of sign-on data determined in the computer system from the certificate.

2. A method according to claim 1, wherein the sign-on data consist of a user name and a password.

3. A method according to claim 1, wherein the certificate is read from a smartcard, by a reader device connected with the computer system.

4. A method according to claim 1, further comprising the step of inputting an identification code assigned to the certificate on the reader device.
